(19) United States
(12) Patent Application Publication
(10) Pub. No.: US 2003/0088796 A1
(43) Pub. Date: May 8, 2003

(54) Communication adapter

(76) Inventor: Soubhi Abdulkarim, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/005,969

(22) Filed: Nov. 6, 2001

(51) Int. Cl. G06F 1/26

(52) U.S. Cl. 713/300

(57) ABSTRACT

Disclosed are a system and method of controlling a communication adapter in response to a sleep message generated by a power management system. In response to a receiving a sleep message, the speed of a clock signal controlling the communication adapter may reduced to place the communication adapter in a lower power state.

### BACKGROUND

1. Field

The subject matter disclosed herein relates to power management systems. In particular, the subject matter disclosed herein relates to power management systems in communication or computing devices.

2. Information

Environmental regulations have imposed restrictions on the rate of power consumption of processing platforms such as personal computer systems. Portability and form factor requirements have also motivated designs of processing platforms with reduced power consumption. Such a processing platform may transition to one or more power states as defined in the Advanced Configuration and Power Interface (ACPI) upon detecting an event or condition. For example, a processing platform may transition to a lower power state and resume to a full power condition upon detection of an event.

In addition to a host processing system, a processing platform may include one or more peripheral devices. Such peripheral devices may include, for example, network adapters and other input/output devices. Peripheral devices typically consume power and contribute to the overall power consumption of the processing platform.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a processing platform according to an embodiment of the present invention.

FIG. 2 shows a flow diagram illustrating a process of placing a communication adapter in a reduced power state according to an embodiment of the processing platform shown in FIG. 1.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions. However, this is merely an example of a storage medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise processing circuitry in combination with machine-executable instructions stored in a memory. However, these are merely examples of structures which may provide logic and embodiments of the present invention are not limited in these respects.

A “processing system” as discussed herein relates to a combination of hardware and software resources for accomplishing computational tasks. However, embodiments of the present invention are not limited in this respect. A “host processing system” relates to a processing system which may be adapted to communicate with a “peripheral device.” For example, a peripheral device may provide inputs to or receive outputs from an application process hosted on the host processing system. However, embodiments of the present invention are not limited in this respect.

A “data bus” as referred to herein relates to circuitry for transmitting data between devices. For example, a data bus may transmit data between a host processing system and a peripheral device. However, this is merely an example and embodiments of the present invention are not limited in this respect. A “bus transaction” as referred to herein relates to an interaction between devices coupled in a bus structure wherein one device transmits data addressed to the other device through the bus structure.

A “device driver” as referred to herein relates to a process hosted on a processing system to facilitate communication between a peripheral device and one or more other processes hosted on the processing system. For example, a device driver may define one or more data items common with other processes on the processing system to enable data to be transmitted to or received from a peripheral device. However, this is merely an example of a device driver and embodiments of the present invention are not limited in this respect.

A “power state” as referred to herein relates to a state in which a processing platform, or subsystem of a processing platform, may consume power. For example, a “reduced power state” may define a state at which power consumption of a device may be reduced from power consumption at a “full power state.” From a reduced power state, the device may “resume” (or be restored) to a full power in response to a condition or event. However, these are merely examples of a power state, full power state, reduced power state and a resume, and embodiments of the present invention are not limited in this respect.

A “power management system” as referred to herein relates to a combination of hardware and software resources in a processing platform to place one or more subsystems of the processing platform in a reduced power state, and cause the one or more subsystems to resume to a full power state in response to a condition or event. However, this is merely an example of a power management system and embodiments of the present invention are not limited in this respect.

A “sleep message” as referred to herein relates to a message provided to a subsystem of a processing platform to place the subsystem in a reduced power state. For example, a device driver may place an associated device in a reduced power state in response to a sleep state. However, this is merely an example of a sleep message and embodiments of the present invention are not limited in this respect.

A “transmission medium” as referred to herein relates to any media suitable for transmitting data. A transmission medium may include any one of several mediums including, for example transmission cabling, optical transmission medium or wireless transmission media. However, these are merely examples of transmission media and embodiments of the present invention are not limited in this respect.

A “communication adapter” as referred to herein relates to a device which may be coupled to a transmission medium to transmit data to or receive data from other devices coupled to the transmission medium. For example, a communication adapter may comprise a network adapter adapted to transmit data to or receive data from devices coupled to a network such as a local area network. Such a network adapter may be communicate with the other devices according to any one of several data communication formats such as, for example, communication formats according any of the IEEE 802.3, asynchronous transfer mode (ATM), synchronous optical network (SONET) or synchronous digital hierarchy (SDH) standards. In alternative embodiments, a communication adapter may comprise any one of other I/O devices such as, for example, an adapter to a data storage system. However, these are merely examples of a communication adapter and embodiments of the present invention are not limited in these respects.

A “clock signal” as referred to herein relates to a periodic signal generated to synchronize or control one or more devices. For example, a clock signal may be generated at a particular “clock speed” or “clock frequency” to control the operation of one or more circuits of a device. However, these are merely examples of a clock signal and a clock speed, and embodiments of the present invention are not limited in this respect.

A “communication protocol” as referred to herein relates to a format or process in which information may be transmitted in a transmission medium between or among devices. A communication protocol may be characterized by a data rate, modulation or encoding format or data encapsulation format. Also, a communication protocol may be characterized by transmitting data between devices in a full-duplex or half-duplex fashion. Also, a communication protocol may, but not necessarily, be applicable to transmitting data in a particular transmission medium. Other communication protocols may define communication formats which are independent of particular transmission media. However, these are merely examples of a communication protocol and embodiments of the present invention are not limited in these respects.

An “auto-select” mode as referred to herein relates to a state of a communication adapter coupled to a first node on a transmission medium while processing data received from the transmission medium. For example, while in an auto-select mode, the communication adapter may process information received from a second node coupled to the transmission medium to determine a communication protocol available for communicating with the second node. However, this is merely an example of an auto-select mode and embodiments of the present invention are not limited in this respect.

Briefly, an embodiment of the present invention relates to a system and method of controlling a communication adapter in response to a sleep message generated by a power management system. In response to a receiving a sleep message, the speed of a clock signal controlling the communication adapter may reduced to place the communication adapter in a reduced power state. However, this is merely an example embodiment and embodiments of the present invention are not limited in this respect.

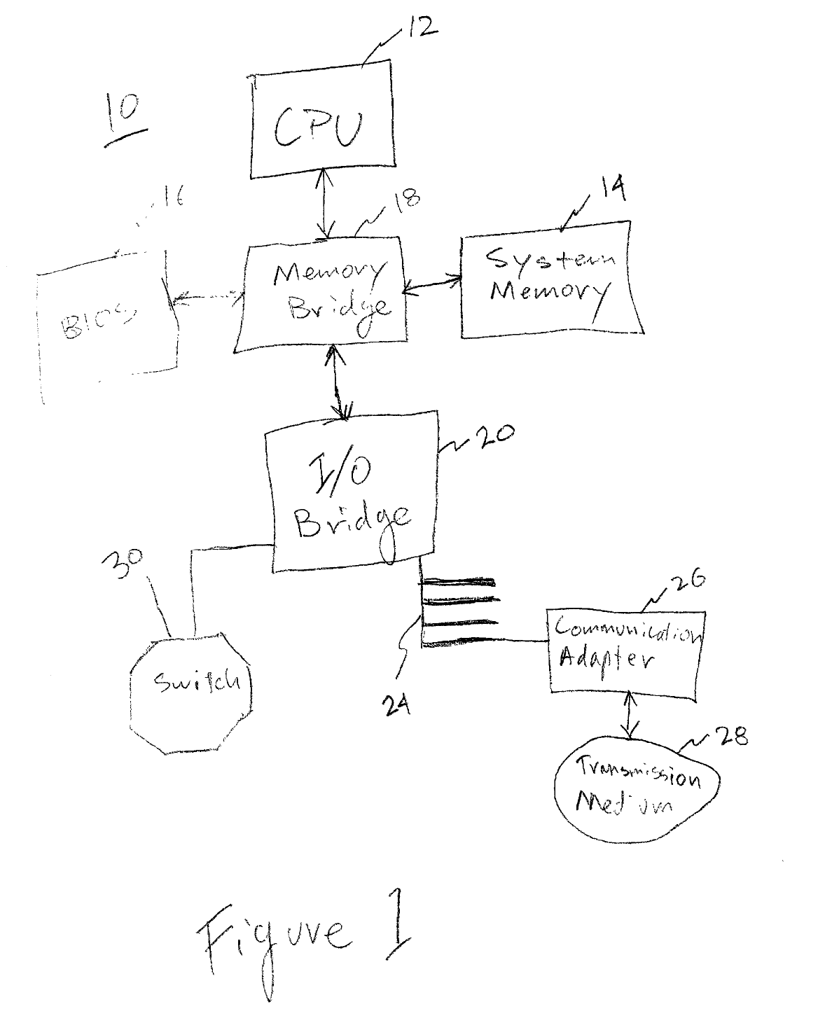

FIG. 1 shows a processing platform 10 according to an embodiment of the present invention. A central processing unit (CPU) 12 and system memory 14 are coupled to a memory bridge 18 to provide a host processing system. A basic input/output system (BIOS) 16 may load firmware instructions to the system memory 14 to be executed by the CPU 12 in response to a reset event. The firmware instructions may comprise routines to initialize the processing system by, for example, loading an operating system and device drivers to the system memory 14 from a non-volatile memory device (not shown).

A data bus 24 is coupled to the memory bridge 18 through an I/O bridge 20 to couple one or more peripheral devices to the memory bridge 18. Such peripheral devices may comprise a communication adapter 26 to transmit data to or received data from a transmission medium 28. In the illustrated embodiment, the data bus 24 may comprise a data bus structure formed according to the Peripheral Components Interconnect (PCI) data bus as provided in the PCI Local Bus Specification Rev. 2.2, Dec. 18, 1998 (hereinafter the “PCI Local Bus Specification”). Also, a switch 30 may be coupled to the I/O bridge at an upstream port to enable point-to-point communication between devices (not shown) coupled to downstream ports independently of the I/O bridge 20. However, these are merely examples of how a peripheral device may be coupled to a host processing system and embodiments of the present invention are not limited in this respect.

The processing platform 10 may comprise a power management system comprising one or processes hosted on the CPU 12 and system memory 14 to communicate with one or more subsystems of the processing platform 10. For example, the power management system may place the subsystems in a reduced power state by providing sleep messages to the subsystems in response to detecting one or more events or conditions. The power management system may cause the subsystems to subsequently resume to a full power state in response to other events. For example, the power management system may place the processing platform 10 in a reduced power state in response to detecting a user input from a mechanical interface (not shown) or detecting an absence of activity at the CPU 12 (e.g., absence of interrupt signals from I/O devices). From the reduced power state, the power management system may transition one or more subsystems of the processing platform 10 to a full power state in response to, for example, a user input from the mechanical interface or detection of an interrupt to the CPU 12. The power management system may be formed according to the Advanced Configuration and Power Interface (ACPI) as illustrated in the ACPI Specification, Rev. 1.0b, Feb. 2, 1999 (hereinafter the “ACPI Specification”). However, these are merely examples of a power management system used in conjunction with a processing platform and embodiments of the present invention are not limited in these respects.

The communication adapter 26 may comprise an interface with the data bus 24 enabling the communication adapter 26 to communicate with processes hosted on processing system using read or write bus transactions. The CPU 12 and system memory 14 may host a device driver that initiates bus transactions to communicate with the communication adapter 26. For example, the device driver may initiate a write transaction on the data bus 24 addressed to the communication adapter 26 to provide data in registers defined at an interface with the communication adapter 26. Additionally, the communication adapter 26 may initiate a write transaction on the data bus 24 to provide data to data buffers in the system memory 14. However, these are merely examples of how a peripheral device may communicate with processes hosted on a processing system through bus transactions and embodiments of the present invention are not limited in these respects.

The communication adapter 26 may comprise a network adapter which is coupled to a communication network such as a local area network (LAN). Such a network adapter may communicate with devices coupled to the communication network using any one of several communication protocols including, for example, communication protocols provided in IEEE 802.3, IEEE 802.3u, IEEE 802.1 lab, ATM and SONET/SDH compliant systems. Alternatively, the communication adapter may comprise other types of input/output devices such as, for example, a small computer system interface (SCSI) device, Fibre-channel, ATA serial bus, Universal Serial Bus, IEEE 1394 and the like. However, these are merely examples of a communication adapter which may transmit data to or receive data from a transmission medium, and embodiments of the present invention are not limited in this respect.

The transmission medium 28 may comprise any medium capable of transmitting data. The transmission medium 28 may comprise category 5, coaxial or optical cabling, or wireless transmission media. The transmission medium 28 may also comprise any combination of the aforementioned cabling or wireless transmission media. However, these are merely examples of media which may be suitable for the transmission of data and embodiments of the present invention are not limited in these respects.

According to an embodiment, the communication adapter 26 may be controlled to transmit data to, or receive data from, the transmission medium 28 according to any one of a plurality of communication protocols. For example, in an embodiment in which the communication adapter 26 comprises a network adapter to communicate with other devices according to communication protocols provided in IEEE 802.3, the communication adapter may comprise logic to perform autonegotiation to select a protocol for communication with the transmission medium from among protocols at different data rates such as 10 Mbps (e.g., 10Base-T), 100 Mbps (e.g., 100Base-T) and 1000 Mbps (e.g., 1000Base-T).

Prior to completing autonegotiation with other devices to select a protocol, the communication adapter 26 may process data received from the transmission medium 28 while in an auto-select mode to determine a protocol for communicating with one or more nodes coupled to the transmission medium 28. In a model 82559ER Fast Ethernet Controller sold by Intel Corporation, for example, a physical unit auto-select function may determine an operational speed of a transmission medium based upon the receipt of link integrity pulses. If no Fast Link Pulses are detected and Normal Link Pulses are detected, the physical unit defaults to 10 MBps operation. If the physical unit detects a line speed change (e.g., detects Fast Link Pulses), it may dynamically change its transmit and receive clock frequencies to match the change in line speed. However, this is merely an example of how a communication adapter may select a communication protocol to transmit data to or receive data from a transmission medium, and embodiments of the present invention are not limited in this respect.

In the presently illustrated embodiment, the communication adapter 26 may comprise circuitry that is synchronized by a periodic clock signal having a clock speed or clock frequency (the terms “clock speed” and “clock frequency” are hereinafter used interchangeably). The clock signal may be internally generated by the communication adapter 26 using techniques know to those of ordinary skill in the art of communication circuit design. However, this is merely an example of how a clock signal may be generated for the purpose of synchronizing circuitry in a communication adapter and embodiments of the present invention are not limited in this respect.

To operate at different protocols or data rates, circuitry of the communication adapter 26 may be synchronized to operate at different speeds as controlled by the aforementioned clock signal. For example, the communication adapter 26 may comprise a media access controller (MAC) circuit (coupled to the data bus 24) and a physical communication circuit (phy) (coupled to the transmission medium 28) which are each controlled by one or more clock signals. In the previous example, where the communication adapter 26 may be adapted to communicate at either a 10 Mbps, 100 Mbs or 1000 Mbps data rates, such a clock signal may be generated at a different corresponding clock speed for each data rate. For operation at 10 Mbps, for example, a serial clock signal may be generated at 2.5 MHz. For operation at 100 Mbps, for example, a serial clock signal may be generated at 25 MHz. For operation at 1000 Mbps, for example, the serial clock signal may be generated at 250 MHz. Accordingly, such a serial clock signal may be generated at a highest clock speed to control the communication adapter 26 to communicate at the 1000 Mbps data rate and generated at the lowest clock speed to control the communication adapter 26 to communicate at the 10 Mbps data rate. However, these are merely examples of how a clock signal may be generated at different clock speeds to control a communication adapter to communicate at different data rates or communication protocols, and embodiments of the present invention are not limited in these respects.

In the illustrated embodiment, the CPU 12 and system memory 14 may host application programs and an operating system to manage processing system resources enabling the application programs. The operating system may comprise encoded modules from any one of several commercially available operating systems such as, for example, versions of Windows™ sold by Microsoft Corporation, VxWork™ or pSOS™ sold by WindRiver, Inc., Solaris™ sold by Sun Microsystems or Linux. However, these are merely examples of operating systems which may be hosted on a processing system, and embodiments of the present invention are not limited in this respect.

In addition to the operating system and application programs, the CPU 12 and system memory 14 may host one or more device drivers to facilitate communication between peripheral devices and other processes hosted on the CPU 12 and system memory 14. In particular, the CPU 12 and system memory 14 may host one or more device drivers associated with the communication adapter 26 to facilitate the transmission of data between the communication adapter 26 and the operating system. For example, such a device driver may define buffer locations in the system memory which are shared by an associated device and the operating system. However, these are merely examples of device drivers and embodiments of the present invention are not limited in this respect.

In some embodiments, the driver may be loaded to the system memory 14 from a non-volatile memory device (e.g., flash memory) in the BIOS 16 in response to a reset event. BIOS routines may then load the operating system to the system memory 14 from an external memory device (e.g., a hard disk drive, not shown) and initialize communication between the operating system and the device driver. In other embodiments, the device driver may be included in one or more modules of the operating system. In other embodiments, device drivers may be layered such that a first portion of device driver (e.g., lower layer) is loaded to the system memory 14 while a second portion of the devices driver is included in one or more modules of the operating system. In this example, the first and second portions may define common data objects at an interface between the first and second portions. However, these are merely examples of a device driver and embodiments of the present invention are not limited in these respects.

According to an embodiment, one or more subsystems of the processing platform 10 may be controlled to be in one of a plurality of power states including a full power state, an off power state, and other intermediate power states. Each intermediate power state may be associated with a reduced rate of power consumption and latency for returning to the full power state in response to a resume procedure. For example, the processing platform 10 may be controllable to be in any of power states S0, S1, S2, S3, S4 or S5 according to the ACPI specification at section 2.4. However, this is merely an example of a power management system which defines a plurality of power states for a processing platform and embodiments of the present invention are not limited in this respect.

According to an embodiment, in response to placing the processing platform 10 in a reduced power state, the power management system may place the communication adapter 26 in a reduced power state by, for example, transmitting a sleep message to the device driver of the communication adapter 26. In one embodiment, the communication adapter 26 may be controllable to be in any of power states DO, D1, D2 or D3 as defined in the ACPI Specification at section 2.3. In response to the sleep message, the device driver may transmit one or more messages to the communication adapter 26 through the data bus 24. In one example, the device driver may initiate a bus transaction to write data to a register of the communication adapter 26 to place the communication adapter in a reduced power state. In response, the communication adapter 26 may initiate one or more subsequent bus transactions to save local data in a location of the system memory 14 before transitioning to the reduced power state. Upon resuming to a full power state, the communication adapter 26 may retrieve the local data from the system memory 14. However, this is merely an example of how a communication adapter may transition to a reduced power state and resume to a full power state, and embodiments of the present invention are not limited in this respect.

In one embodiment, the communication adapter 26 comprises an interface with the data bus 24 to receive messages from the device driver to specify a communication protocol, or control the clock speed of a clock signal controlling one or more circuits of the communication adapter 26. Such an interface may be accessible through a read or write transaction on the data bus 24 addressed to the communication adapter. In response to receiving a sleep message from the power management system, the device driver may place the communication adapter 26 in a reduced power state by writing to a register in this interface to either specify a lower clock speed to control the one or more circuits of the communication adapter 16 or specify a communication protocol using less power (e.g., a communication protocol that causes the communication adapter 26 to use less power). However, this is merely an example of how a device driver may place a communication adapter in a reduced power state in response to a sleep message and embodiments of the present invention are not limited in this respect.

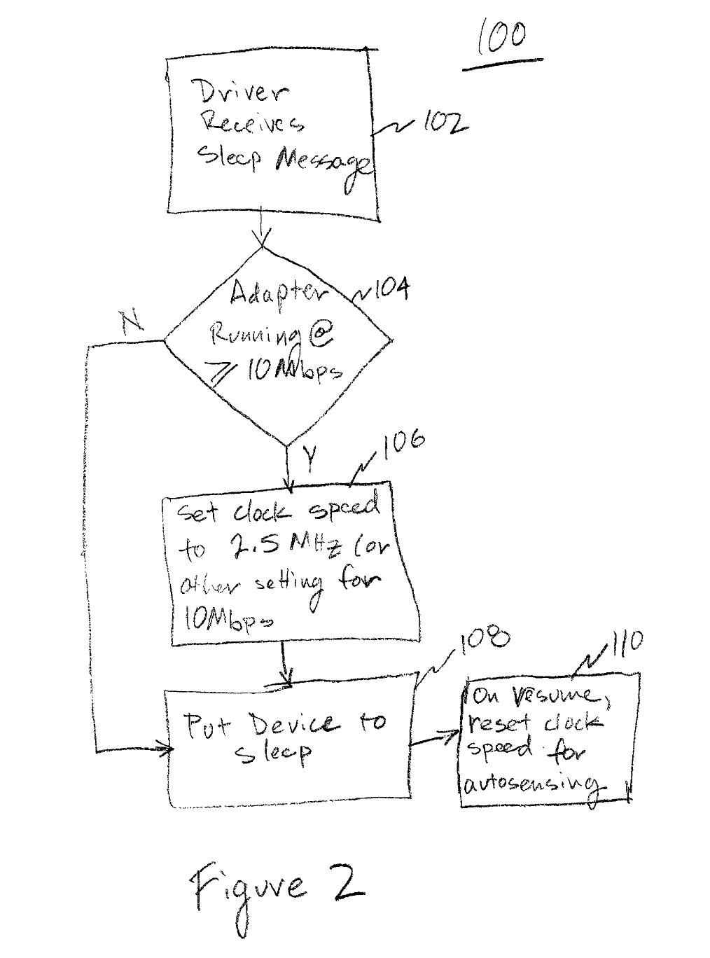

FIG. 2 shows a flow diagram illustrating a process 100 of placing a communication adapter in a reduced power state according to an embodiment of the processing platform shown in FIG. 1. In the illustrated embodiment, the process 100 may be controlled by a device driver hosted on the CPU 12 and system memory 14. However, this is merely an example implementation of a process to place a communication adapter in a reduced power state and embodiments of the present invention are not limited in this respect

At block 102, the device driver may receive a sleep message from the power management system indicating that the processing platform 10 is transitioning to a reduced power state (e.g., from S0 to S1, S2, S3 or S4 as defined in the ACPI specification). This signal may be provided by the power management system in a data item in the system memory 14 which is accessible by the device driver as part of a call to the device driver. However, this is merely an example of how a device driver may receive a sleep message indicating a transition to a lower power state and embodiments of the present invention are not limited in this respect.

Upon receipt of a sleep message at block 102, diamond 104 determines whether the communication adapter 26 is operating at a higher power state (e.g., a power state which consumes more power than while operating at the reduced power state). In the illustrated embodiment, diamond 104 determines whether the communication adapter is operating at state to support a communication protocol having a data rate exceeding a threshold data rate corresponding with the reduced power state. For example, the communication adapter 26 may comprise logic to communicate with other nodes coupled to the transmission medium 28 according to any of the 10Base-T, 100Base-T or 1000Base-T communication protocols defined in versions of the IEEE standard 802.3. As the communication adapter 26 may consume more power at the 100Base-T (at 100 Mbps) or 1000Base-T (at 1000 Mbps) protocols than at the 10Base-T protocol (at 10 Mbps), diamond 104 may apply a threshold data rate at 10 Mbps to determine whether the communication adapter 26 is operating at a state which consumes more power than the lowest power state.

In an alternative embodiment, block 104 may determine that a clock signal controlling circuitry of the communication adapter 26 has a clock speed above a threshold clock speed. In the illustrated embodiment, the threshold clock speed may be a clock speed for controlling the communication adapter to operate at a lowest data rate (e.g., 10 Mpbs at 10 Base-T). This clock speed may be provided in a data item which is maintained by the communication adapter (e.g., through bus transactions on the data bus 24) and accessible by the device driver. In an embodiment in which the communication adapter 26 comprises a 82559ER Fast Ethernet controller sold by Intel Corporation, for example, a Management Data Interface (MDI) may provide status information and accept management information. Here, bits 11 through 14 in register 1 may indicate a current operation mode of the physical circuit. These bits may be examined upon transitioning to a reduced power state to determine whether the clock speed is set for operating at 10 Mbps or 100 Mbps. However, these are merely examples of how a device driver may determine whether an associated communication adapter is operating at a higher power state, and embodiments of the present invention are not limited in these respects.

If the communication adapter 26 is not operating the higher power state (e.g., to support a communication protocol having a data rate that does not exceed the threshold data rate) at diamond 104, block 108 may initiate a procedure to place the communication adapter in the lower power state. Such a procedure at block 108 may include, for example, writing data to the system memory 14 to preserve the local system state and removing power from one or more portions of the communication adapter 26. Otherwise, if diamond 104 determines that the communication is operating at a higher power state (e.g., to support a communication protocol having a data rate exceeding the threshold data rate), block 106 causes the communication adapter 26 to operate at the lower power state by, for example, causing the speed of the clock signal to be lowered (e.g., a clock speed corresponding with the reduced power state) prior to the procedure initiated at block 108. Block 108 may then cause the communication adapter 26 to complete a transition to a reduced power state as discussed above. With the lowered clock speed, the communication adapter 26 may then consume less power than at the clock speed applied for operating at the protocol having the higher data rate.

Following a transition of the communication adapter 26 to the lower power state at block 108, the power management system may provide a resume signal to the device driver indicating that the processing platform 10 is resuming to a full power state. In response to the resume signal, the device driver may provide a signal to the communication adapter 26 to “awaken” the communication adapter from the reduced power state at block 110 by, for example, resetting the speed of the clock signal controlling circuitry of the communication adapter 26. The device driver may reset the speed or frequency of the clock signal by, for example, initiating subsequent a write transaction on the data bus 24 to the register in the interface of the communication adapter 26 specifying the clock speed. The reset clock signal may then maintain the communication adapter 26 in an autosensing mode to process data received from the transmission medium 28.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system comprising:
a processing system; and
a communication adapter adapted to be coupled to a transmission medium,
wherein the processing system further comprises:
logic to receive a sleep message from a power management system; and
logic to place the communication adapter in a sleep state in response to the sleep message.

2. The system of claim 1, wherein the processing system further comprises logic to selectively lower a speed of a clock signal to control the communication adapter.

3. The system of claim 2, wherein the processing systems further comprises logic to selectively lower the speed of the clock from a first clock speed to a second speed, wherein the first clock speed controls the communication adapter to communicate with a transmission medium according to a first communication protocol and the second clock speed controls the communication adapter to communicate with the transmission medium according to a second communication protocol.

4. The system of claim 2, wherein the processing system further comprises:
logic to determine the speed of the clock signal in response to the sleep message; and
logic to selectively lower the speed of the clock signal if the speed of the clock signal exceeds a predetermined clock speed.

5. The system of claim 2, wherein the processing system further comprises:
logic to determine a first communication protocol being used by the communication adapter in response to the sleep message; and
logic to selectively command the communication adapter to use a second communication protocol if a data rate or clock signal associated with the first communication protocol exceeds a threshold.

6. The system of claim 1, wherein the processing system further comprises logic to place the communication adapter in an auto-select state in response to a resume message.

7. The system of claim 1, wherein the system further comprises a data bus coupled between the communication adapter and the processing system, and wherein the processing system further comprises logic to selectively initiate a write command on the data bus addressed to the communication adapter specifying a change in one of a clock signal frequency and a communication protocol in response to the sleep message.

8. An article comprising
a storage medium comprising machine-readable instructions stored thereon for:
receiving a sleep message; and
placing a communication adapter in a sleep state in response to the sleep message.

9. The article of claim 8, wherein the storage medium further comprises machine-readable instructions stored thereon for selectively lowering a speed of a clock signal to control the communication adapter.

10. The article of claim 9, wherein the storage medium further comprises machine-readable instructions stored thereon for selectively lowering the speed of the clock from a first clock speed to a second speed, wherein the first clock speed controls the communication adapter to communicate with a transmission medium according to a first protocol and the second clock speed controls the communication adapter to communicate with the transmission medium according to a second protocol.

11. The article of claim 9, wherein the storage medium further comprises machine-readable instructions stored thereon for:
determining the speed of the clock signal in response to the sleep message; and
selectively lowering the speed of the clock signal if the speed of the clock signal exceeds a predetermined clock speed.

12. The article of claim 9, wherein the storage medium further comprises machine-readable instructions stored thereon for:
determining a first communication protocol being used by the communication adapter in response to the sleep message; and
selectively commanding the communication adapter to use a second communication protocol if a data rate or clock signal frequency associated with the first communication protocol exceeds a threshold.

13. The article of claim 8, wherein the storage medium further comprises machine-readable instructions stored thereon for placing the communication adapter in an auto-sensing state in response to a resume message.

14. A method comprising:
receiving a sleep message; and
placing a communication adapter in a sleep state in response to the sleep message.

15. The method of claim 14, wherein the method further comprises selectively lowering a speed of a clock signal to control the communication adapter.

16. The method of claim 15, wherein the method further comprises selectively lowering the speed of the clock from a first clock speed to a second speed, wherein the first clock speed controls the communication adapter to communicate with a transmission medium according to a first communication protocol and the second clock speed controls the communication adapter to communicate with the transmission medium according to a second communication protocol.

17. The method of claim 15, wherein the method further comprises:
determining the speed of the clock signal in response to the sleep message; and
selectively lowering the speed of the clock signal if the speed of the clock signal exceeds a predetermined clock speed.

18. The method of claim 15, wherein the method further comprises:
determining a first communication protocol being used by the communication adapter in response to the sleep message; and
selectively commanding the communication adapter to use a second communication protocol if a data rate or clock signal associated with the first communication protocol exceeds a threshold.

19. The method of claim 14, wherein the method further comprises placing the communication adapter in an auto-select state in response to a resume message.

20. An apparatus comprising:
means for receiving a sleep message; and
means for placing a communication adapter in a sleep state in response to the sleep message.

21. The apparatus of claim 20, wherein the apparatus further comprises means for selectively lowering a speed of a clock signal to control the communication adapter.

22. The apparatus of claim 21, wherein the apparatus further comprises means for selectively lowering the speed of the clock from a first clock speed to a second speed, wherein the first clock speed controls the communication adapter to communicate with a transmission medium according to a first communication protocol and the second clock speed controls the communication adapter to communicate with the transmission medium according to a second communication protocol.

23. The apparatus of claim 21, wherein the apparatus further comprises:
means for determining the speed of the clock signal in response to the sleep message; and
means for selectively lowering the speed of the clock signal if the speed of the clock signal exceeds a predetermined clock speed.

24. The apparatus of claim 21, wherein the apparatus further comprises:
means for determining a first communication protocol being used by the communication adapter in response to the sleep message; and
means for selectively commanding the communication adapter to use a second communication protocol if a data rate or clock signal associated with the first communication protocol exceeds a threshold.

25. The apparatus of claim 20, wherein the apparatus further comprises means for placing the communication adapter in an auto-select state in response to a resume message.
